(19) United States
(12) Patent Application Publication
(10) Pub. No.: US 2026/0240380 A1
(43) Pub. Date: Aug. 20, 2026

(54) WINDOW CLEANING MACHINE HAVING DOUBLE ROLLING BRUSHES

(71) Applicant: Dongguan Enjoy Intelligent Technology Co., Ltd, Dongguan (CN)

(72) Inventor: Hongjun He, Mianyang (CN)

(21) Appl. No.: 19/056,803

(22) Filed: Feb. 19, 2025

(51) Int. Cl. A47L 1/02; B08B 1/12

(52) U.S. Cl. CPC A47L 1/02; B08B 1/12

(57) ABSTRACT

Disclosed is a window cleaning machine having double rolling brushes. The window cleaning machine includes a supporting rack, where a middle of the supporting rack is fixedly connected to a negative pressure fan, two ends of a bottom of the supporting rack are provided with assembly grooves, rolling brush assemblies are assembled inside the two assembly grooves respectively, and the rolling brush assemblies are used for cleaning glass. A middle of a bottom end of the supporting rack is fixedly connected to a plurality of limiting posts, and a floating plate is arranged among the plurality of limiting posts in a sleeving manner. Each rolling brush assembly includes a positioning seat, a positioning disc, locking claws A, matching locking holes A and a transmission seat, the positioning seat and the transmission seat are fixedly connected at two ends of an interior of the corresponding assembly groove respectively.

### TECHNICAL FIELD

The present disclosure relates to the technical field of glass cleaning, and in particular to a window cleaning machine having double rolling brushes.

### BACKGROUND

A window is an opening between a building or other enclosed space and the outside world. The main function of the window is to introduce natural light and fresh air into a room, improve comfort and reduce energy consumption. In addition, the window can provide outdoor views, increase house value and improve the indoor air quality.

In order to ensure the transmittance of light of the window, it is necessary to clean on the window regularly. Since cleaning of the side of the glass located outdoors has certain risks, at present, cleaning is mainly completed through a window cleaning machine.

However, when the window cleaning machine in the prior art is applied, a space for a power source of a cleaning assembly needs to be reserved in a housing. Under the condition of more power sources, the integration degree of the whole is greatly affected, such that the whole size is large, and use is not convenient enough.

Therefore, the present disclosure provides a window cleaning machine having double rolling brushes, so as to solve the above problems.

### SUMMARY

In view of the defects of the prior art, the present disclosure provides a window cleaning machine having double rolling brushes, which solves the above problems.

In order to achieve the above objective, the present disclosure is implemented through the following technical solutions: a window cleaning machine having double rolling brushes includes a supporting rack, where a middle of the supporting rack is fixedly connected to a negative pressure fan, two ends of a bottom of the supporting rack are provided with assembly grooves, rolling brush assemblies are assembled inside the two assembly grooves respectively, and the rolling brush assemblies are used for cleaning glass. A middle of a bottom end of the supporting rack is fixedly connected to a plurality of limiting posts, and a floating plate is arranged among the plurality of limiting posts in a sleeving manner.

Preferably, each rolling brush assembly includes a positioning seat, a positioning disc, locking claws A, matching locking holes A and a transmission seat, and the positioning seat and the transmission seat are fixedly connected at two ends of an interior of the corresponding assembly groove respectively. One side of the positioning seat is rotationally connected to the positioning disc, and an edge of one side of the positioning disc is fixedly connected to a plurality of locking claws A. The end, close to the locking claws A, of a rolling brush main body is provided with the matching locking holes A, and the rolling brush main body is connected to the locking claws A through the matching locking holes A in a clamped manner.

One side of the transmission seat is fixedly connected to a loading disc, and an edge of one side of the loading disc is fixedly connected to a plurality of locking claws B. Outer sides of the locking claws B are connected to a transmission housing, and an interior of the transmission housing is fixedly connected to a transmission motor. A middle of an interior of the rolling brush main body is fixedly connected to a transmission disc, and an output end of the transmission motor is fixedly connected to the transmission disc.

Preferably, a top end of the supporting rack is fixedly connected to a protective housing, and one side of the protective housing is provided with an air outlet.

Preferably, water spray heads are fixedly connected to both sides of the supporting rack, a controller and a liquid storage tank are arranged inside the supporting rack, and a pump body is provided on the liquid storage tank. An input end of the pump body is connected to the liquid storage tank, an output end of the pump body is connected to the water spray heads through pipes, and the pump body is also electrically connected to the controller.

Preferably, detection sensors are fixedly connected to four end corners of the supporting rack, and each detection sensor is electrically connected to the controller.

Preferably, two sides of the supporting rack are provided with storage grooves, and interiors of the storage grooves are provided with traveling crawler belts for driving the supporting rack to travel.

Preferably, a plurality of guide plates are fixedly connected to an edge of one side of the positioning disc, and guide notches are formed between the guide plates and the locking claws A. The end, close to the guide notches, of an inner wall of the rolling brush main body is fixedly connected to limiting strips, and the limiting strips are also assembled inside the guide notches.

Preferably, one ends of the locking claws A and one ends of the locking claws B each are both provided with a pressure block, and a top end of each pressure block is provided with a pressure slope. The locking claws A are connected inside the matching locking holes A through the pressure blocks in a clamped manner, the end, close to the locking claws B, of the transmission housing is provided with a plurality of matching locking holes B, and the locking claws B are connected inside the matching locking holes B through the pressure blocks in a clamped manner.

Preferably, a stability maintaining plate is fixedly connected to one side of the loading disc, a plurality of stability maintaining wheels are rotationally connected between the stability maintaining plate and the loading disc, and the end, close to the stability maintaining wheels, of the rolling brush main body is arranged on the stability maintaining wheels in a sleeving manner.

### Beneficial effects

The present disclosure provides the window cleaning machine having double rolling brushes. Compared with the prior art, the following beneficial effects are realized:

According to the window cleaning machine having double rolling brushes, through structural cooperation of the rolling brush assemblies, integrated mounting of the rolling brush main bodies and the transmission motors is realized without occupying an internal space of the supporting rack, such that the whole size is effectively controlled, and the window cleaning machine is more suitable for outdoor use.

According to the window cleaning machine having double rolling brushes, the locking claws A and the locking claws B are arranged, such that positioning of the roller brush main bodies and the transmission housings can be realized in a clamping manner, use of connecting members such as screws is omitted, and subsequent maintenance is more convenient and faster.

### BRIEF DESCRIPTION OF DRAWINGS

FIG. 1 is a schematic diagram of the present disclosure.

FIG. 2 is an exploded diagram of the present disclosure.

FIG. 3 is an upward view of the present disclosure.

FIG. 4 is a schematic structural diagram of the present disclosure in the case of dismounting of rolling brush assemblies.

FIG. 5 is a schematic structural diagram of a rolling brush assembly of the present disclosure.

FIG. 6 is a schematic structural diagram showing separation between locking claws A and matching locking holes A of the present disclosure.

FIG. 7 is a schematic structural diagram showing separation between a transmission housing and locking claws B of the present disclosure.

In the figures, 1. supporting rack; 2. negative pressure fan; 3. assembly groove; 4. rolling brush assembly; 5. protective housing; 6. limiting post; 7. floating plate; 8. water spray head; 9. detection sensor; 10. traveling crawler belt; 11. rolling brush main body; 12. positioning seat; 13. positioning disc; 14. locking claw A; 15. matching locking hole A; 16. transmission seat; 17. loading disc; 18. locking claw B; 19. transmission housing; 20. matching locking hole B; 21. transmission motor; 22. transmission disc; 23. guide plate; 24. guide notch; 25. limiting strip; 26. pressure block; 27. stability maintaining wheel; and 28. stability maintaining plate.

### DESCRIPTION OF EMBODIMENTS

The technical solutions in the examples of the present disclosure will be clearly and completely described below with reference to the accompanying drawings in the examples of the present disclosure. Obviously, the described examples are merely some examples rather than all examples of the present disclosure. All the other examples obtained by those of ordinary skill in the art based on the examples in the present disclosure without creative efforts shall fall within the scope of protection of the present disclosure.

### Example 1:

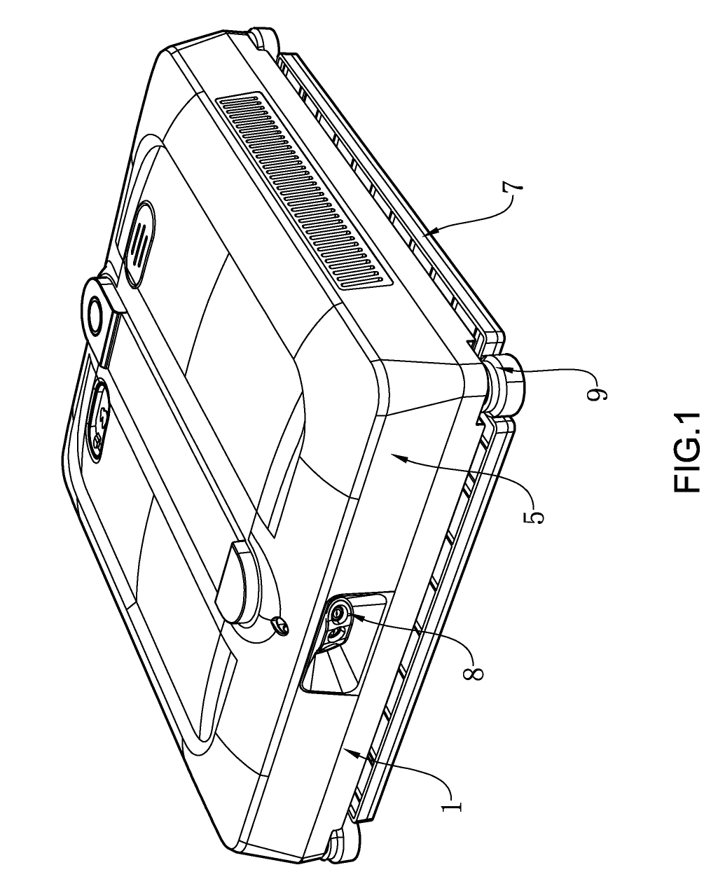

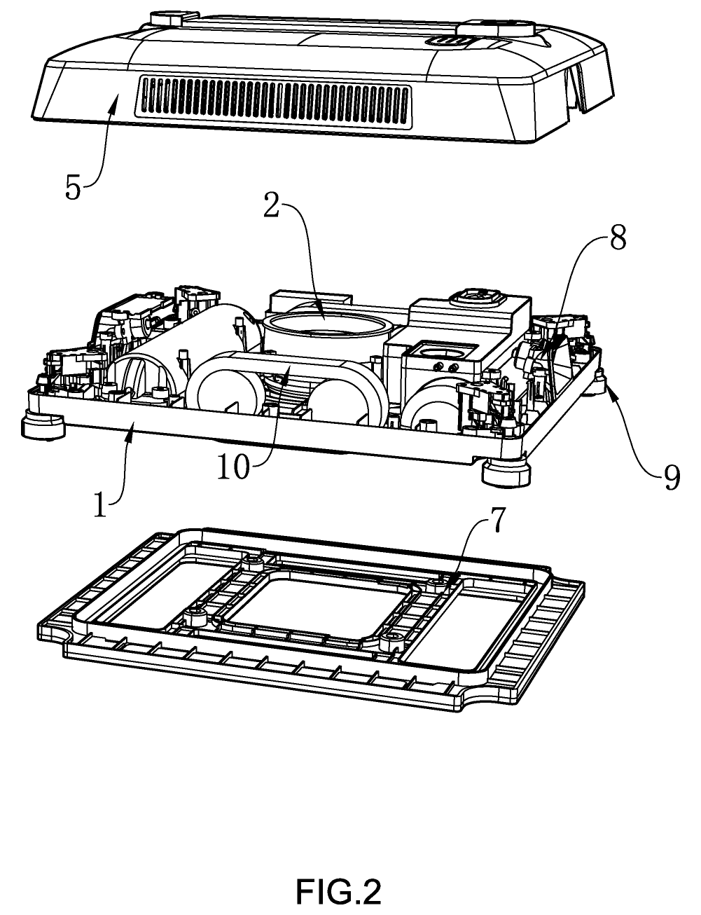

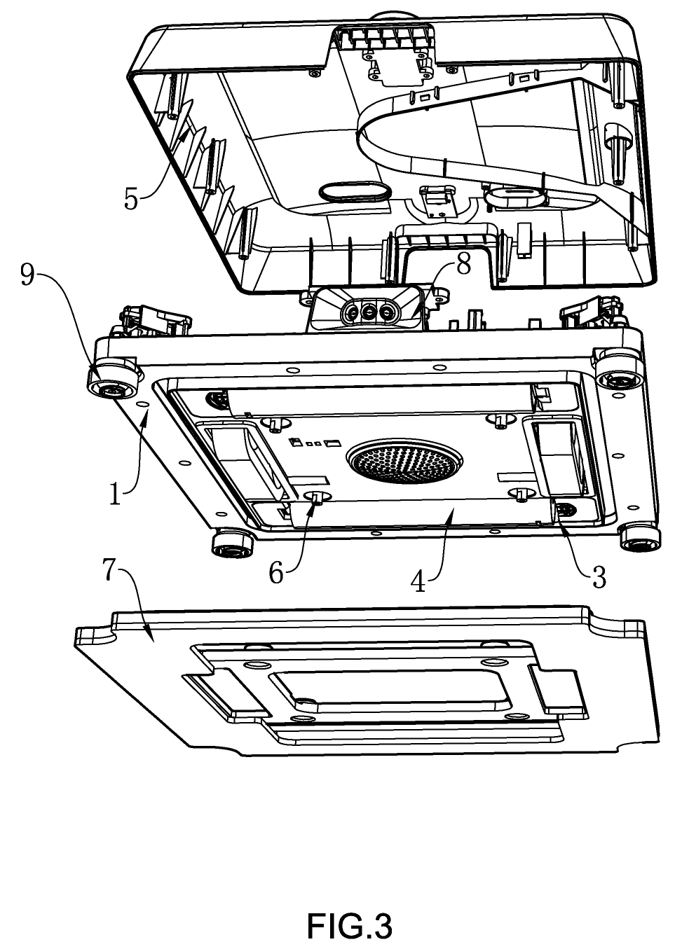

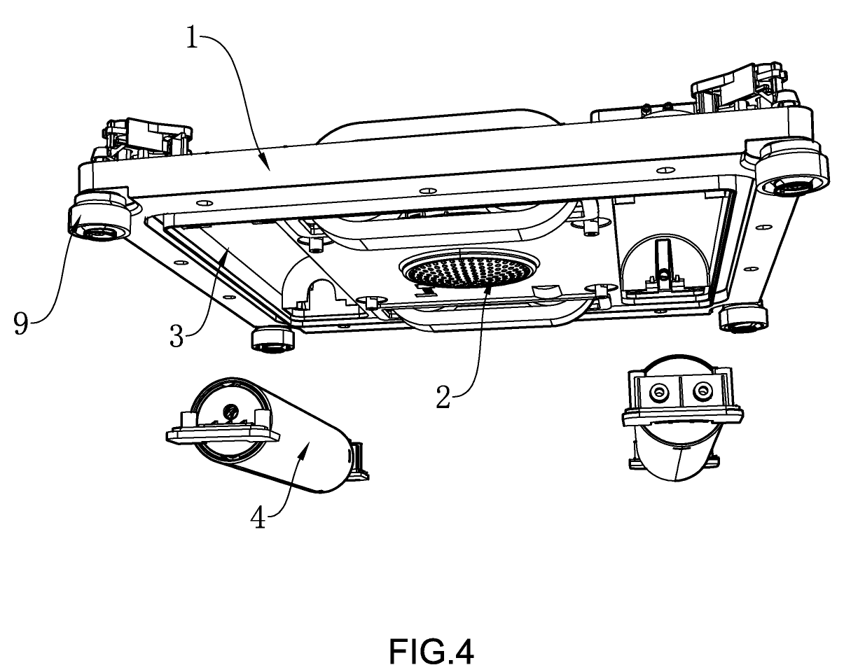

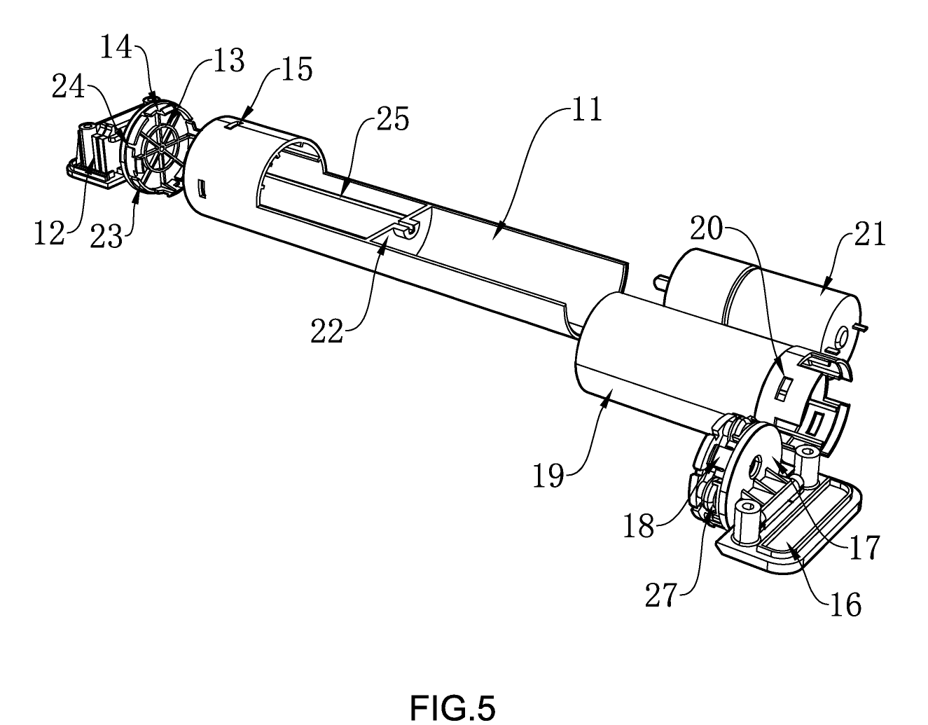

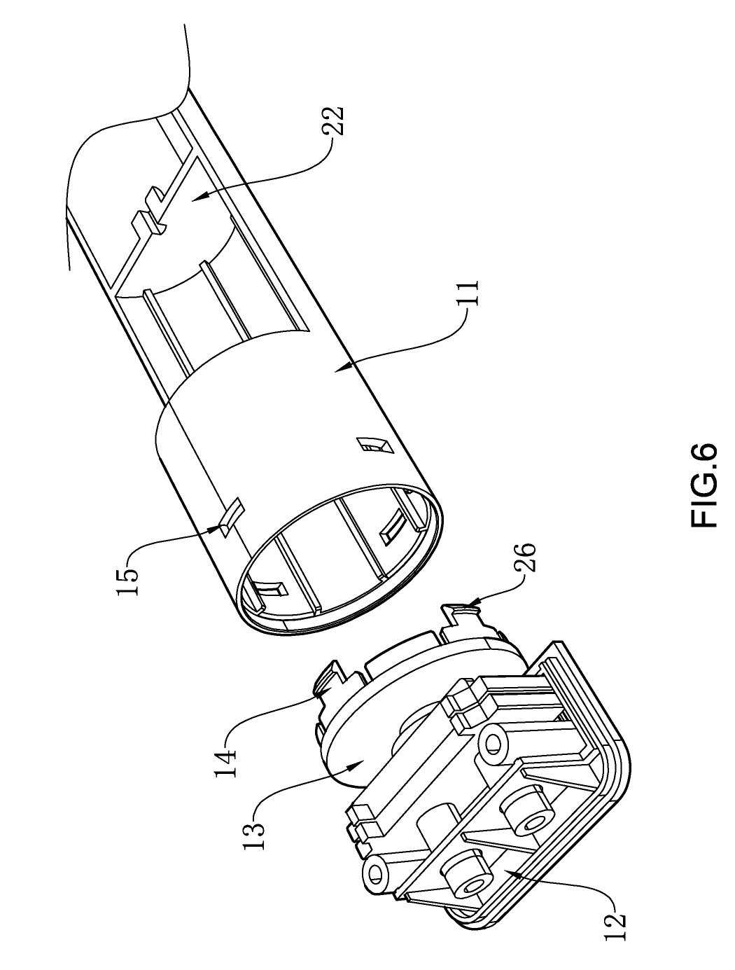

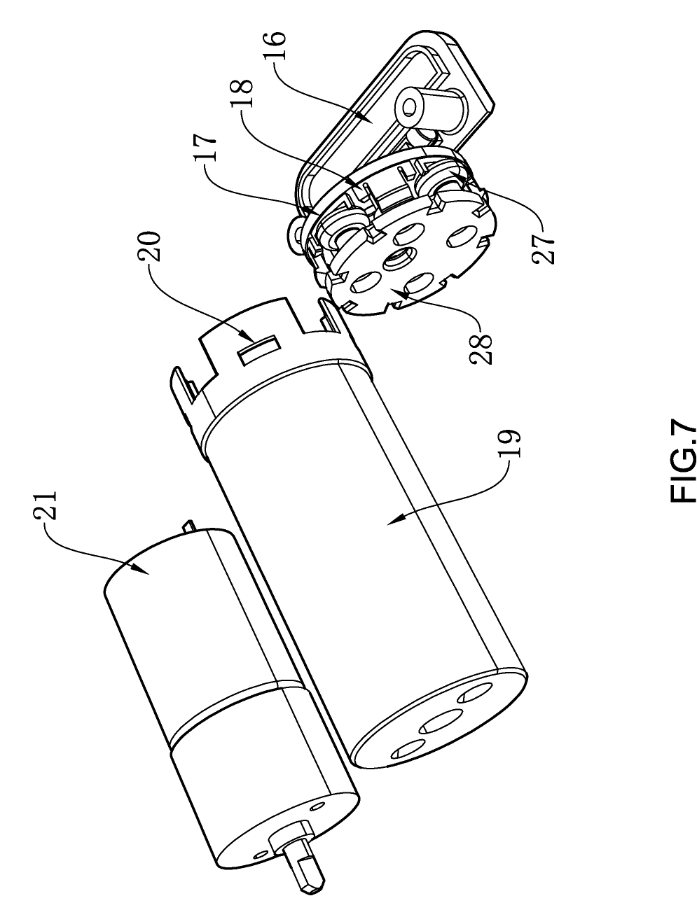

Referring to FIGS. 1-7, a window cleaning machine having double rolling brushes includes a supporting rack 1, where a middle of the supporting rack 1 is fixedly connected to a negative pressure fan 2, two ends of a bottom of the supporting rack 1 are provided with assembly grooves 3, rolling brush assemblies 4 are assembled inside the two assembly grooves 3 respectively, and the rolling brush assemblies 4 are used for cleaning glass. A middle of a bottom end of the supporting rack 1 is fixedly connected to a plurality of limiting posts 6, and a floating plate 7 is arranged among the plurality of limiting posts 6 in a sleeving manner.

In this example, the negative pressure fan 2 is used for sucking the supporting rack 1 onto window glass.

Specifically, a top end of the supporting rack 1 is fixedly connected to a protective housing 5, and one side of the protective housing 5 is provided with an air outlet. Through the arrangement of the air outlet, components at the supporting rack 1 can be protected, such that the components are prevented from damaged. In combination with the arrangement of the air outlet, heat generated during running of the components at the supporting rack 1 can be timely led out.

Here, water spray heads 8 are fixedly connected to both sides of the supporting rack 1, a controller and a liquid storage tank are arranged inside the supporting rack 1, and a pump body is provided on the liquid storage tank. An input end of the pump body is connected to the liquid storage tank, an output end of the pump body is connected to the water spray heads 8 through pipes, and the pump body is also electrically connected to the controller.

Specifically, detection sensors 9 are fixedly connected to four end corners of the supporting rack 1, and each detection sensor 9 is electrically connected to the controller. Through the arrangement of the detection sensors 9, the traveling position of the supporting rack 1 can be detected, so as to avoid the supporting rack 1 from falling off when moving to an edge of a window.

Specifically, two sides of the supporting rack 1 are provided with storage grooves, and interiors of the storage grooves are provided with traveling crawler belts 10 for driving the supporting rack 1 to travel. In this example, a power source used for supplying power to the traveling crawler belts 10 is further arranged on the supporting rack 1.

### Example 2:

Referring to FIGS. 1-7, this example provides a technical solution on the basis of Example 1 as follows: each rolling brush assembly 4 includes a positioning seat 12, a positioning disc 13, locking claws A 14, matching locking holes A 15 and a transmission seat 16, and the positioning seat 12 and the transmission seat 16 are fixedly connected at two ends of an interior of the corresponding assembly groove 3 respectively. One side of the positioning seat 12 is rotationally connected to the positioning disc 13, and an edge of one side of the positioning disc 13 is fixedly connected to a plurality of locking claws A 14. The end, close to the locking claws A 14, of a rolling brush main body 11 is provided with the matching locking holes A 15, and the rolling brush main body 11 is connected to the locking claws A 14 through the matching locking holes A 15 in a clamped manner.

In this example, the positioning seat 12 and the transmission seat 16 are both connected to the interior of the corresponding assembly groove 3 through screws, such that the positioning seat 12 and the transmission seat 16 can be conveniently detached from the assembly groove 3 later.

Preferably, a plurality of guide plates 23 are fixedly connected to an edge of one side of the positioning disc 13, and guide notches 24 formed between the guide plates 23 and the locking claws A 14. The end, close to the guide notches 24, of an inner wall of the rolling brush main body 11 is fixedly connected to limiting strips 25, and the limiting strips 25 are also assembled inside the guide notches 24. Through structural cooperation between the guide notches 24 and the limiting strips 25, in the sleeving arrangement process of the rolling brush main body 11, the positions of the locking claws A 14 always correspond to the matching locking holes A 15, so as to ensure the assembly effect of the locking claws A 14 and the matching locking holes A 15.

One side of the transmission seat 16 is fixedly connected to a loading disc 17, and an edge of one side of the loading disc 17 is fixedly connected to a plurality of locking claws B 18. Outer sides of the locking claws B 18 are connected to a transmission housing 19 in a clamped manner, and an interior of the transmission housing 19 is fixedly connected to a transmission motor 21. A middle of an interior of the rolling brush main body 11 is fixedly connected to a transmission disc 22, and an output end of the transmission motor 21 is fixedly connected to the transmission disc 22.

Here, one ends of the locking claws A 14 and one ends of the locking claws B 18 each are both provided with a pressure block 26, and a top end of each pressure block 26 is provided with a pressure slope. The locking claws A 14 are connected inside the matching locking holes A 15 through the pressure blocks 26 in a clamped manner, and the end, close to the locking claws B 18, of the transmission housing 19 is provided with a plurality of matching locking holes B 20, and the locking claws B 18 are connected inside the matching locking holes B 20 through the pressure blocks 26 in a clamped manner. Due to the arrangement of the pressure slopes, when the rolling brush main body 11 makes contact with the pressure slopes, the rolling brush main body 11 can press the locking claws A 14, when the transmission housing 19 makes contact with the locking claws B 18, the transmission housing 19 presses the locking claws B 18, and the locking claws A 14 and the locking claws B 18 are further driven to be deformed. When the pressure blocks 26 correspond to the matching locking holes B 20 or the matching locking holes A 15, and since the pressure blocks 26 lose blocking, the pressure blocks 26 can be clamped into the matching locking holes A 15 or the matching locking holes B 20.

Further, a stability maintaining plate 28 is fixedly connected to one side of the loading disc 17, a plurality of stability maintaining wheels 27 are rotationally connected between the stability maintaining plate 28 and the loading disc 17, and the end, close to the stability maintaining wheels 27, of the rolling brush main body 11 is arranged on the stability maintaining wheels 27 in a sleeving manner. Through the arrangement of the stability maintaining wheels 27, the end, far away from the locking claws A 14, of the rolling brush main body 11 can be supported in an auxiliary manner, ensuring the successful rotation of the rolling brush main body 11.

Moreover, the content not described in detail in the description belongs to the prior art well known to those skilled in the art.

Working principle: Firstly, the end, provided with the matching locking holes A 15 of the rolling brush main body 11 is made to correspond to the locking claws A 14, and then, the rolling brush main body 11 is pushed, such that the rolling brush main body 11 is made to press the pressure blocks 26 at the locking claws A 14, thereby driving the locking claws A 14 to be deformed. Next, the rolling brush main body 11 is pushed, such that the rolling brush main body 11 is made to be arranged outside the locking claws A 14 in a sleeving manner. When the pressure blocks 26 at the locking claws A 14 correspond to the matching locking holes A 15, the locking claws A 14 can be reset because the pressure blocks 26 lose limiting, and the pressure blocks 26 are driven to be clamped into the matching locking holes A 15, thereby forming the quick assembly of the rolling brush main body 11.

Moreover, the transmission motor 21 is arranged inside the transmission housing 19, and the transmission housing 19 is made to correspond to the locking claws B 18. Then, the transmission housing 19 is pushed, such that the transmission housing 19 presses the pressure blocks 26 at the locking claws B 18, thereby driving the locking claws B 18 to be deformed. When the pressure blocks 26 correspond to the matching locking holes B 20, the pressure blocks 26 can be clamped inside the matching locking holes B 20, thereby realizing rapid assembly of the transmission housing 19. After the transmission motor 21 is connected to the transmission disc 22, the rolling brush main body 11 can be driven to rotate under support of the positioning disc 13 and the stability maintaining wheels 27 by starting the transmission motor 21. When the supporting rack 1 moves, contact between the rotating rolling brush main body 11 and glass can be used for effectively cleaning the glass.

It should be noted that relational terms herein such as first and second are only used for distinguishing one entity or operation from another entity or operation without necessarily requiring or implying any actual such relationship or order between such entities or operations. In addition, terms “comprise”, “include”, “contain”, or any other variations thereof are intended to cover non-exclusive inclusions, such that a process, a method, an article, or a device including a series of elements not only includes those elements, but also includes other elements that are not explicitly listed, or also includes inherent elements of the process, the method, the article, or the device.

Although the examples of the present disclosure have been illustrated and described, it should be understood that those of ordinary skill in the art may make various changes, modifications, replacements and variations to these examples without departing from the principle and spirit of the present disclosure, and the scope of the present disclosure is limited by the appended claims and their legal equivalents.

What is claimed is:

1. A window cleaning machine having double rolling brushes, comprising a supporting rack, wherein a middle of the supporting rack is fixedly connected to a negative pressure fan, two ends of a bottom of the supporting rack are provided with assembly grooves, rolling brush assemblies are assembled inside the two assembly grooves respectively, the rolling brush assemblies are used for cleaning glass, a middle of a bottom end of the supporting rack is fixedly connected to a plurality of limiting posts, and a floating plate is arranged among the plurality of limiting posts in a sleeving manner.

2. The window cleaning machine having double rolling brushes according to claim 1, wherein each rolling brush assembly comprises a positioning seat, a positioning disc, locking claws A, matching locking holes A and a transmission seat, the positioning seat and the transmission seat are fixedly connected at two ends of an interior of the corresponding assembly groove respectively, one side of the positioning seat is rotationally connected to the positioning disc, an edge of one side of the positioning disc is fixedly connected to a plurality of locking claws A, the end, close to the locking claws A, of a rolling brush main body is provided with the matching locking holes A, and the rolling brush main body is connected to the locking claws A through the matching locking holes A in a clamped manner; and
one side of the transmission seat is fixedly connected to a loading disc, an edge of one side of the loading disc is fixedly connected to a plurality of locking claws B, outer sides of the locking claws B are connected to a transmission housing in a clamped manner, an interior of the transmission housing is fixedly connected to a transmission motor, a middle of an interior of the rolling brush main body is fixedly connected to a transmission disc, and an output end of the transmission motor is fixedly connected to the transmission disc.

3. The window cleaning machine having double rolling brushes according to claim 1, wherein a top end of the supporting rack is fixedly connected to a protective housing, and one side of the protective housing is provided with an air outlet.

4. The window cleaning machine having double rolling brushes according to claim 1, wherein water spray heads are fixedly connected to both sides of the supporting rack, a controller and a liquid storage tank are arranged inside the supporting rack, a pump body is provided on the liquid storage tank, an input end of the pump body is connected to the liquid storage tank, an output end of the pump body is connected to the water spray heads through pipes, and the pump body is also electrically connected to the controller.

5. The window cleaning machine having double rolling brushes according to claim 4, wherein detection sensors are fixedly connected to four end corners of the supporting rack and each detection sensor is electrically connected to the controller.

6. The window cleaning machine having double rolling brushes according to claim 1, wherein two sides of the supporting rack are provided with storage grooves, and interiors of the storage grooves are provided with traveling crawler belts for driving the supporting rack to travel.

7. The window cleaning machine having double rolling brushes according to claim 2, wherein a plurality of guide plates are fixedly connected to an edge of one side of the positioning disc, guide notches are formed between the guide plates and the locking claws A, the end, close to the guide notches, of an inner wall of the rolling brush main body is fixedly connected to limiting strips, and the limiting strips are also assembled inside the guide notches.

8. The window cleaning machine having double rolling brushes according to claim 2, wherein one ends of the locking claws A and one ends of the locking claws B each are both provided with a pressure block, a top end of each pressure block is provided with a pressure slope, the locking claws A are connected inside the matching locking holes A through the pressure blocks in a clamped manner, the end, close to the locking claws B, of the transmission housing is provided with a plurality of matching locking holes B, and the locking claws B are connected inside the matching locking holes B through the pressure blocks in a clamped manner.

9. The window cleaning machine having double rolling brushes according to claim 2, wherein a stability maintaining plate is fixedly connected to one side of the loading disc, a plurality of stability maintaining wheels are rotationally connected between the stability maintaining plate and the loading disc, and the end, close to the stability maintaining wheels, of the rolling brush main body is arranged on the stability maintaining wheels in a sleeving manner.
